(19) United States
(12) Patent Application Publication
(10) Pub. No.: US 2011/0207619 A1
(43) Pub. Date: Aug. 25, 2011

(54) ARRANGEMENT FOR PROCESSING A PLURALITY OF SAMPLES FOR ANALYSIS

(76) Inventors: Thomas Ehben, Weisendorf (DE); Mitja Schonecke, Bubenreuth (DE); Christian Zilch, Leipzig (DE)

(21) Appl. No.: 12/448,015

(22) PCT Filed: Nov. 29, 2007
(86) PCT No.: PCT/EP2007/062977

§ 371 Date: Jun. 4, 2009

(30) Foreign Application Priority Data
Dec. 5, 2006 (DE) 10 2006 057 300.5

(51) Int. Cl. C40B 30/04; C40B 60/04

(52) U.S. Cl. 506/9; 506/35

(57) ABSTRACT

An arrangement is provided in at least one embodiment, having a magazine for supplying a plurality of microfluidic devices. The microfluidic devices each contain at least one element/device for binding at least one biological molecule, wherein the at least one element/device for binding the at least one biological molecule can be moved relative to the microfluidic device. A sample presumably containing biological molecules to be examined is introduced into the microfluidic device. The biological molecule to be examined is bound by the at least one element/device for binding the biological molecule. In at least one embodiment, the at least one element/device for binding the at least one biological molecule, or the substrate-molecule complex, can then be moved in the microfluidic device, e.g. in accordance with a predetermined reaction sequence, for example by means of a magnetic field. The microfluidic device is transported through the arrangement.

### PRIORITY STATEMENT

This application is the national phase under 35 U.S.C. §371 of PCT International Application No. PCT/EP2007/062977 which has an International filing date of Nov. 29, 2007, which designated the United States of America, and which claims priority on German patent application number DE 10 2006 057 300.5 filed Dec. 5, 2006, the entire contents of each of which are hereby incorporated herein by reference.

### FIELD

At least one embodiment of the invention generally relates to an arrangement for processing a plurality of samples for analysis, which has an arrangement, microfluidic devices for receiving samples and at least one device for moving the microfluidic devices in the arrangement. At least one embodiment of the invention furthermore relates to a method for processing a plurality of samples for analysis.

### BACKGROUND

In biotechnological analysis, in recent years high throughput methods (high throughput screening, HTS) have been developed in order to be able to process a large number of samples in a short time. Hole plate formats have predominantly been used here, e.g. 96-hole plates or 384-hole plates, wherein each hole or each depression in a plate constitutes a reaction vessel. The disadvantage of such methods is that liquids have to be pipetted over from supply vessels to the plate or from plate to plate, which is mechanically complicated and entails risks of contamination.

In addition, fully integrated microfluidic analysis devices have also been developed, wherein, instead of reaction vessels, process chambers are used which are connected via lines or channels, as described e.g. in DE 101 11 457 A1. These devices can be contained in a fully encapsulated manner in a cartridge, a card-like flat structure, wherein process chambers for sample processing, amplification of analytes, e.g. nucleic acids, and for detection of analytes, e.g. in the form of biochips with nucleic acid microarrays, are provided in the device. Analysis devices of this type have the advantage that the analysis can proceed completely in the encapsulated analysis device, such that risks of contamination or operating errors are largely precluded.

Devices of this type can be used for analyzing nucleic acids, e.g. DNA sequences or RNA sequences, proteins and other biomolecules. Even complex assay sequences can be carried out in a manner free of contamination and errors in such an analysis device in microfluidic arrangements of process chambers and connecting channels. One disadvantage of these systems, however, is the low sample throughput, that is to say the small number of assays that can be carried out per time. Particularly in the case of nucleic acid-based systems that require amplification of the DNA or RNA, a total duration of the assay of one hour or more is by no means an exception. Generally, in this case firstly the sample is introduced manually into the analysis device, and the latter is then inserted into a control or read-out unit, in which the process steps are processed automatically. At the end of the assay, the analysis device is manually removed from the control unit. This process sequence requires regular manual intervention by the operating personnel and significantly restricts the throughput.

Theoretically, it is possible to use fully integrated diagnostic systems for complex assays with many biological issues (e.g. multiparameter studies such as the cytochrome P 450 analysis or CFTR) in central laboratories as well. In this case, however, the low throughput is a major disadvantage and leads to prohibitively high costs. In established high throughput methods, e.g. the above-described methods on hole plate formats, the processing of the samples for analysis is complicated. This processing can be carried out with comparatively little complexity in microfluidic devices, however, e.g. by disrupting the sample, binding the analytes to magnetic substrates, so-called magnetic beads, fixing the substrate-analyte complex by way of an external magnetic field in the analysis device and removing undesirable sample constituents by rinsing the fixed substrate-analyte complexes with a washing liquid, as described e.g. in DE 101 11 520 B4. However, methods of this type have not had high throughput capability heretofore.

### SUMMARY

At least one embodiment of the present invention provides an arrangement and a method for processing a plurality of samples for analysis which can be implemented in a fully integrated analysis device and is simultaneously suitable for processing high numbers of samples.

The arrangement according to at least one embodiment of the invention is for processing a plurality of samples for analysis comprising:
a) a receptacle for a microfluidic device, wherein at least one device/element for binding at least one biological molecule is provided in the microfluidic device; and
b) at least one device/element for moving the microfluidic device in the arrangement along at least one predetermined direction of movement;
wherein the arrangement has at least one magazine for supplying a plurality of microfluidic devices.

Preferably, the arrangement has a unit for moving provided in the microfluidic device for binding at least one biological molecule relative to the microfluidic device. The unit preferably comprises a magnetic field generator.

The expression “microfluidic device” relates to a device in which fluid volumes in the microliters range can be manipulated, e.g. microfluidic cartridges such as are generally known in the art.

Preferably, the arrangement according to at least one embodiment of the invention furthermore has at least one device/element for amplifying the biological molecule in the microfluidic device.

Furthermore, the arrangement according to at least one embodiment of the invention comprises at least one device/element for detecting the biological molecule.

The arrangement according to at least one embodiment of the invention furthermore preferably comprises a unit for introducing a sample into a microfluidic device.

In accordance with one preferred aspect of at least one embodiment of the invention, the arrangement comprises a container for collecting used microfluidic devices.

In accordance with one preferred aspect of at least one embodiment of the invention, the arrangement comprises a stack-like magazine in which the microfluidic devices can be stacked.

In accordance with an alternative aspect of at least one embodiment of the invention, the arrangement comprises a drum-like magazine in which the microfluidic devices can be rolled up on a roll.

In accordance with a further preferred aspect of at least one embodiment of the invention, the arrangement comprises at least one device/element for detecting a coding of a microfluidic device.

According to at least one embodiment of the invention, a sample that presumably contains biological molecules to be examined is introduced into the microfluidic device, wherein, in the microfluidic device, the biological molecule to be examined is bound by the at least one device/element for binding and processing of the sample is thus made possible. A further microfluidic device can be loaded from the magazine, and can be filled with the next sample. As an alternative, a plurality of microfluidic devices can be filled with the samples before being introduced into the arrangement. The microfluidic devices are transported through the arrangement along the at least one predetermined direction of movement and the samples can in this way be processed successively in an automated manner.

Preferably, the at least one device/element for binding the at least one biological molecule are embodied as a substrate that can be linked to the biological molecule to be examined to form a substrate-molecule complex.

In accordance with one aspect of at least one embodiment of the present invention, the substrate has a protein-binding property, which can preferably be embodied as an antibody directed to the biological molecule.

In accordance with an alternative aspect of at least one embodiment of the present invention, the substrate has a nucleic acid-binding property, wherein the nucleic acid-binding property is preferably embodied non-sequence-specifically, e.g. as silane, or as probe oligonucleotid (sequence-specifically).

In accordance with a further aspect of at least one embodiment of the present invention, the substrate has both at least one protein-binding property and at least one nucleic acid-binding property.

Preferably, the at least one device/element for binding at least one biological molecule comprise at least one magnetic element, e.g. magnetic bead, which can be moved and/or fixed by a magnetic field.

Preferably, the arrangement has at least one device/element for amplifying the molecule. This can comprise, e.g. if the molecule is a nucleic acid, an amplification chamber in the microfluidic device, in which an amplification reaction, e.g. the polymerase chain reaction (PCR), or a comparable amplification method, can take place. Heating and/or cooling elements, e.g. peltier elements, can be provided in the arrangement in order to carry out such a reaction.

Furthermore, the arrangement according to at least one embodiment of the invention preferably has at least one device/element for detecting the molecule. The detection can be effected e.g. by magnetic, optical, florescence-optical, electrochemical, gravimetric and other suitable methods. For this purpose, a detection chamber is provided in the microfluidic device, which detection chamber can have a nucleic acid microarray, for example, on which probe oligonucleotides for the detection of nucleic acid molecules are provided. Electrochemical detection is particularly preferred. For this purpose, an electrochemical sensor, e.g. in the form of electrodes, is provided in the microfluidic device. At least one device/element for measuring currents and/or voltages is/are provided in the arrangement. A corresponding measurement method that can be used in this case is described e.g. in DE 101 26 341 A1. In accordance with an alternative aspect, magnetic detection is preferred. For this purpose, a magnetoresistive sensor can be provided in the arrangement.

In accordance with a further aspect of at least one embodiment of the present invention, the microfluidic device comprises at least one process chamber which at least temporarily contains the at least one device/element for binding at least one biological molecule. The at least one process chamber can be embodied as a processing chamber for using the at least one device/element for binding the at least one biological molecule, as an amplification chamber for using the at least one device/element for amplifying the at least one biological molecule, and/or as a detection chamber for detecting the at least one biological molecule. Provision can preferably be made of a plurality of process chambers which are arranged along a reaction section and can be connected by lines at least occasionally. The lines can be embodied as microfluidic channels with valves fitted thereto. The valves can be embodied as simple elastic pinch valves or magnetically controllable valves in order to fluidically separate the different process chambers from one another. The valves can also be embodied in other ways known to the person skilled in the art.

In accordance with one preferred aspect of at least one embodiment of the present invention, a plurality of groups of process chambers can be provided in a microfluidic device, wherein the process chambers in a group are preferably arranged in each case along a reaction section and the process chambers of a group along the respective reaction section can be fluidically connected by lines at least occasionally. In this way it is possible to realize a plurality of sample sections e.g. in a parallel fashion on the microfluidic device. Sample ports arranged parallel can be situated at one end of the respective reaction sections, which ports can be sealed by septa. At the other end, there can be provided as detection devices/elements e.g. correspondingly a plurality of microarrays arranged parallel or else alternatively a microarray common to the individual reaction sections and serving for detecting the target molecules in all the biological samples applied. The sample ports can be connected to the microarrays along the reaction section via various process chambers (e.g. processing, washing and amplification chambers) and lines.

A microfluidic device of this type can be used as a single-use element in the arrangement according to the invention. The single-use element can be embodied as an elongate device, e.g. in the form of a cartridge, that is to say a card-like flat structure. Preferably, the chambers and lines are oriented along the reaction section in the elongate device along the at least one direction of movement with which the elongate device is transported through the control unit. It is noted that the microfluidic device having a plurality of parallel reaction sections as described in this paragraph is considered to constitute an autonomous embodiment of the invention which is independent of the rest of the arrangement and which likewise achieves the object formulated initially.

Furthermore, a container for collecting the used microfluidic devices is preferably provided in the arrangement.

The microfluidic devices can be discarded and disposed of after single use. However, it is also conceivable that they can be reused, e.g. after cleaning or regeneration.

The arrangement can have a stack-like magazine in which the microfluidic devices are stacked. As an alternative, it is also possible to provide a drum-like magazine, for example, in which the microfluidic devices are rolled up on a roll.

Preferably, the arrangement has a unit for introducing a sample into a microfluidic device. This can be configured as an automated pipetting device, for example, which can pipette a sample into the microfluidic device. If a plurality of parallel reaction sections for the parallel processing of samples are provided on the microfluidic device, the unit for introducing a sample into the microfluidic device preferably has a corresponding number of channels in order to introduce the corresponding number of samples in one work step.

At least one device/element for moving or transporting the microfluidic device along at least one predetermined direction of movement is/are provided in the control unit; these transport devices/elements can be embodied e.g. in the form of a conveyor belt.

In accordance with a further aspect of at least one embodiment of the present invention, at least one device/element for moving the substrate-molecule complex relative to the microfluidic device are furthermore provided, which preferably comprise a magnetic field generator. By moving the microfluidic device relative to the magnetic field generator, or by moving the magnetic field generator relative to the microfluidic device, it is possible for the substrate-molecule complex having magnetic beads to be moved relative to the microfluidic device, that is to say e.g. along the reaction path through the process chambers. In this case, the magnetic beads are retained in the magnetic field of the magnetic field generator, while the microfluidic device is moved relative to the magnetic field generator (or vice versa).

In accordance with a further aspect of at least one embodiment of the present invention, the microfluidic devices have a marking by which they can be coded. In this way it is possible to detect an assignment between applied sample and the single-use element. For this purpose, at least one device/element for detecting the marking are preferably provided in the arrangement. The marking can comprise a conventional type of marking known to the person skilled in the art, e.g. a bar code, an RFID, or the like. Corresponding devices/elements for reading out the marking are then preferably present in the arrangement. Furthermore, the arrangement can be connected via interfaces to a data processing system that is used to register the microfluidic devices on the basis of the marking and to store data read out. Preferably, microfluidic devices once used can be rendered invalid by way of the data processing system, in order to preclude multiple reading.

The following procedure is performed when processing a plurality of samples for analysis:

An arrangement is provided which has a magazine for the supply of a plurality of microfluidic devices. The microfluidic devices each contain at least one device/element for binding at least one biological molecule, wherein the at least one device/element for binding the at least one biological molecule can be moved relative to the microfluidic device.

A sample that presumably contains biological molecules to be examined is introduced into the microfluidic device. Optionally, the sample can firstly be disrupted in the microfluidic device, e.g. by using a lysis buffer. The biological molecule to be examined is bound by the at least one device/element for binding the biological molecule. Preferably, the at least one device/element for binding the at least one biological molecule are embodied as a substrate that can be linked to the molecule to form a substrate-molecule complex. The at least one device/element for binding the at least one biological molecule, or the substrate-molecule complex, can then be moved in the microfluidic device, e.g. in accordance with a predetermined reaction sequence.

In accordance with a further aspect of at least one embodiment of the present invention, after the binding of the molecule, the substrate-molecule complex can be separated from the remainder of the sample. This can be done by moving the substrate-molecule complex relative to the rest of the sample volume, e.g. by magnetically fixing the substrate-molecule complex and rinsing away the sample.

At least one device/element for pumping fluids into the microfluidic device and/or out of the microfluidic device can be provided in the arrangement. They can be embodied e.g. as lines, channels, with corresponding filling or extracting units, using corresponding fluid transport systems, e.g. piston pumps, peristaltic pumps and other pumps known to the person skilled in the art.

In accordance with a further aspect of at least one embodiment of the present invention, the molecule can also be separated from the substrate again in the course of the method, e.g. by separating the substrate-molecule complex bond, e.g. by heating, changing the salt concentration or the like.

In accordance with one preferred aspect of at least one embodiment of the invention, the method has an additional step of amplification of the molecule by way of an amplification reaction. Furthermore, the method preferably has the additional step of detection of the molecule.

In the method according to at least one embodiment of the invention, the at least one device/element for binding the at least one molecule is preferably moved along a reaction section in the microfluidic device, which leads into at least one process chamber.

Preferably, a plurality of process chambers are arranged along the reaction section. In accordance with a further aspect of at least one embodiment of the present invention, in the method, in the microfluidic device, a plurality of samples are processed simultaneously in a corresponding number of reaction sections which are arranged essentially parallel in the microfluidic device.

Preferably, the microfluidic devices are loaded from the magazine, pass through the arrangement along the at least one predetermined direction of movement and are then ejected from the arrangement or transported into a container for collecting used microfluidic devices.

At least one embodiment of the invention furthermore relates to a method for processing a plurality of samples for analysis, having the following steps:
a) supply of an arrangement with a plurality of microfluidic devices, wherein the arrangement has at least one magazine for supply with microfluidic devices and wherein the microfluidic devices each contain at least one device/element for binding at least one biological molecule;
b) introduction of a first sample, containing at least one biological molecule to be examined, into one of the microfluidic devices;
c) binding of the biological molecule to be examined by the at least one device/element for binding at least one biological molecule; and
d) repetition of steps b)-c) with the further samples until all the samples to be processed have been processed;
wherein the microfluidic device with the introduced sample is moved in the arrangement along at least one predetermined direction of movement.

In this case, the at least one device/element for binding the at least one biological molecule can preferably be moved relative to the microfluidic device.

Preferably, the introduction of the samples, containing biological molecules to be examined, into the respective microfluidic devices is effected before the supply of the arrangement with microfluidic devices.

In accordance with one preferred aspect of the method according to at least one embodiment of the invention, the at least one device/element for binding the at least one biological molecule are embodied as a substrate that can be linked to the molecule to form a substrate-molecule complex.

Preferably, after the binding of the molecule to the substrate, the substrate-molecule complex is separated from the rest of the sample.

In accordance with one preferred aspect of at least one embodiment of the method according to the invention, the separation of the substrate-molecule complex from the rest of the sample is effected by moving the substrate-molecule complex relative to the rest of the sample.

In accordance with one preferred aspect of at least one embodiment of the method according to the invention, the at least one device/element for binding the at least one biological molecule comprise at least one magnetic element.

In accordance with one preferred aspect of the method according to at least one embodiment of the invention, a magnetic field is used for moving the at least one device/element for binding the at least one biological molecule relative to the microfluidic device.

In accordance with one preferred aspect of the method according to at least one embodiment of the invention, the method according to the invention has the additional step of amplification of the biological molecule by way of an amplification reaction.

In accordance with one preferred aspect of the method according to at least one embodiment of the invention, the method according to at least one embodiment of the invention has the additional step of detection of the biological molecule.

In accordance with one preferred aspect of the method according to at least one embodiment of the invention, the biological molecule is detected magnetically, electrochemically or optically.

In accordance with one preferred aspect of the method according to at least one embodiment of the invention, the at least one device/element for binding the at least one molecule is moved along a reaction section in the microfluidic device, which leads into at least one process chamber.

In accordance with one preferred aspect of the method according to at least one embodiment of the invention, the at least one device/element for binding the at least one molecule is moved along a reaction section in the microfluidic device through a plurality of process chambers.

In accordance with one preferred aspect of the method according to at least one embodiment of the invention, the reaction section is oriented essentially along the at least one predetermined direction of movement in the arrangement.

In accordance with one preferred aspect of the method according to at least one embodiment of the invention, in this case, in the at least single-use element, a plurality of samples are processed simultaneously in a corresponding number of reaction sections which are arranged essentially parallel in the microfluidic device.

Preferably, the microfluidic devices are loaded from the magazine, pass through the arrangement along the at least one predetermined direction of movement and are then ejected from the arrangement or transported into a container for collecting used microfluidic devices.

### BRIEF DESCRIPTION OF THE DRAWINGS

Further aspects, properties and advantages of the present invention are illustrated on the basis of the following description of example embodiments and the appended drawings, in which:

FIG. 1 shows a schematic illustration of a first embodiment of a microfluidic device for receiving a sample in the arrangement according to an embodiment of the invention;

FIG. 2 shows a second embodiment of a microfluidic device in the arrangement according to an embodiment of the invention;

FIG. 3 shows a third embodiment of the microfluidic device in the arrangement according to an embodiment of the invention;

FIG. 4 shows a first embodiment of the arrangement according to an embodiment of the invention in a first operating state;

FIG. 5 shows a first embodiment of the arrangement according to an embodiment of the invention in a second operating state;

FIG. 6 shows a first embodiment of the arrangement according to an embodiment of the invention in a third operating state; and

FIG. 7 shows a second embodiment of the arrangement according to an embodiment of the invention.

### DETAILED DESCRIPTION OF THE EXAMPLE EMBODIMENTS

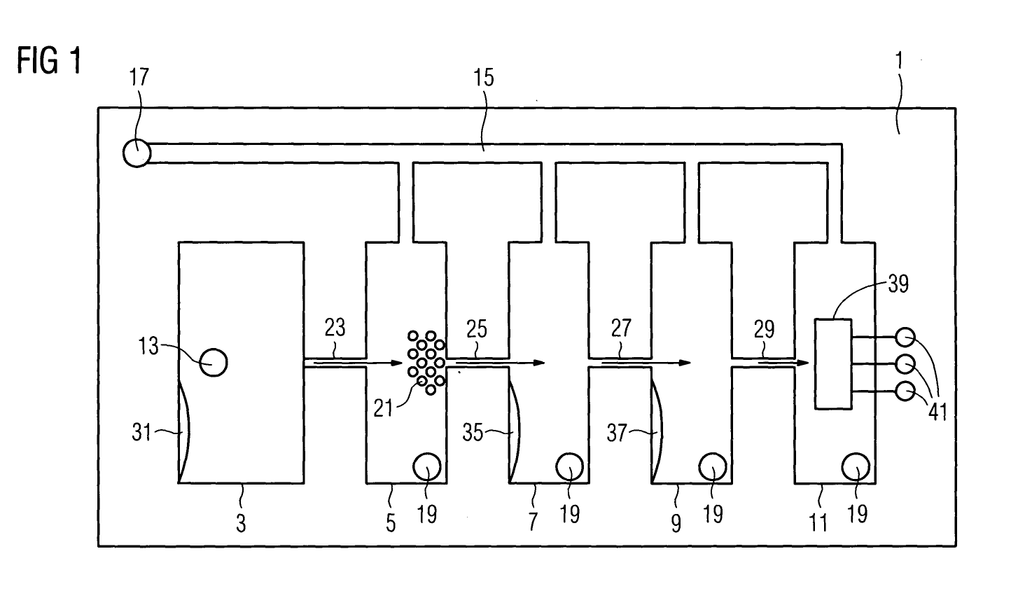

FIG. 1 schematically illustrates a microfluidic device which is used in the arrangement according to the invention, in the form of a cartridge 1. The latter is embodied as a card-like flat structure and can be produced e.g. as a plastic injection-molded part, depressions present therein being configured in the form of chambers and channels. Reagents required for the subsequent processes and reactions, e.g. in the form of dry reagents, can be introduced into the cartridge, e.g. by being spotted on in the corresponding chambers. Sealing the upwardly open cartridge, e.g. with a plastic film, creates a closed microfluidic device with process chambers and lines situated therein. The cartridge 1 comprises a processing chamber 3, a disruption chamber 5, a washing chamber 7, an amplification chamber 9 and a detection chamber 11. The processing chamber 3 comprises a filling opening 13, via which the sample to be examined can be introduced into the processing chamber 3 for example by way of a syringe or pipette. The process chambers 5, 7, 9, 11 are connected via a microchannel 15 to an opening 17, via which water or buffer can be introduced into the process chambers in a manner known per se.

The filling opening 13 and/or opening 17 can be closed off by way of a septum in order to ensure sterility and/or to prevent contaminations and entrainments. Apart from the processing chamber 3, each process chamber 5, 7, 9, 11 has a venting opening 19 closed off by a gas-permeable membrane, for example. It can thus be ensured that gas can leave the process chambers, but liquid cannot leave them. A lysis reagent 31, e.g. in dry form, is stored beforehand in the processing chamber. The lysis reagent is dissolved by the introduction of the (liquid) sample, e.g. blood or some other sample liquid. Biological structures, e.g. cells, bacteria, viruses, are lysed by the dissolved lysis reagent and release biological molecules contained therein.

The sample is then displaced from the chamber 3 into the chamber 5 via the line 23, e.g. by subsequent rinsing with buffer. Magnetic beads 21 in the dry state are stored beforehand in the chamber 5, and, as a result of the sample being transferred into the chamber 5, the magnetic beads 21 are suspended and distributed in the sample. Probe oligonucleotides are provided on the magnetic beads, and bind target molecules sought, e.g. nucleic acids complementary to the probe oligonucleotides, with the result that a substrate-molecule complex is formed, wherein the magnetic beads represent the substrate. As an alternative, antibodies that bind specific target proteins or nucleic acids can also be provided on the magnetic beads. The antibodies can be polyclonal or monoclonal antibodies. As an alterative, at least one device/element which bind nucleic acids non-specifically, e.g. silanes, randomized oligonucleotides or the like, can also be provided on the magnetic beads. Furthermore, it is conceivable for other substances that bind specific biological molecules and structures, e.g. carbohydrates, lipopolysaccharides and the like, to be applied on the beads.

In accordance with one alternative embodiment, the magnetic beads can also be provided in the chamber 3 and have binding properties (e.g. antibodies, polysaccharides, and the like) which specifically bind specific biological structures in the sample, e.g. specific cells, bacteria or viruses.

The process chambers are interconnected by microchannels 23, 25, 27 and 29 in accordance with the order of the process steps that proceed, said microchannels being embodied in such a way that an interfering exchange of liquid between the process chambers is largely prevented during the processing and analysis and has no interfering influence. On the other hand, the microchannels 23, 25, 27 and 29 are large enough to permit magnetic beads 21 with bound structures or molecules to pass through. The diameter of the microchannels 23, 25, 27 and 29 is typically of the order of magnitude of several μm. As an alternative, with larger dimensioning of the microchannels, it is also possible to provide valves in the microchannels 23, 25, 27, 29 in order to fluidically separate the individual process chambers 3, 5, 7, 9, 11 from one another during the method sequence. In the chamber 5, the disruption of the biological structures can be completed and non-bound sample constituents can be separated from the molecules bound to the substrate (that is to say the magnetic beads) by subsequent rinsing with washing solution or buffer.

A further washing chamber 7 is provided in order to eliminate cell residues and other contaminants that are possibly still present. The complexes composed of magnetic beads 21 and nucleic acids (or composed of magnetic beads and proteins in the case of a protein-binding property of the magnetic beads) are moved through the microchannel 25 into the washing chamber 7. By way of example chaotropic salts 35 can be stored in the washing chamber 7, which salts are initially present in dry form and dissolve as a result of the washing chamber 7 being filled.

For complex processing and analysis methods it is possible to provide additional chambers.

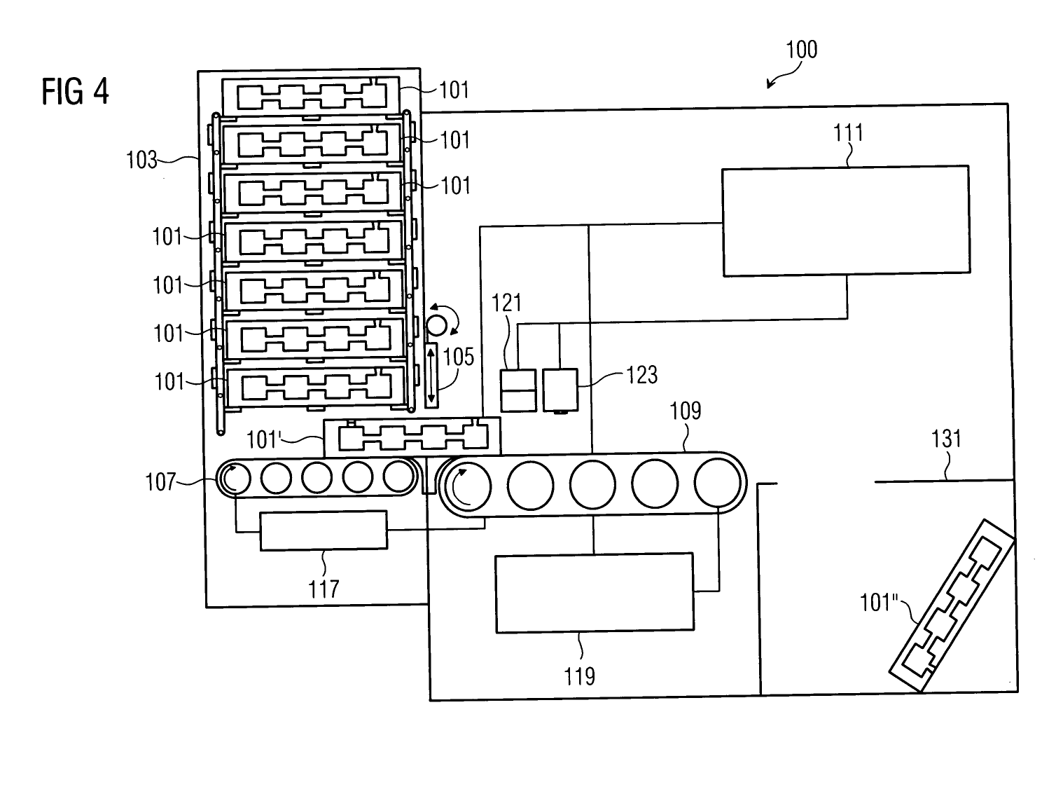

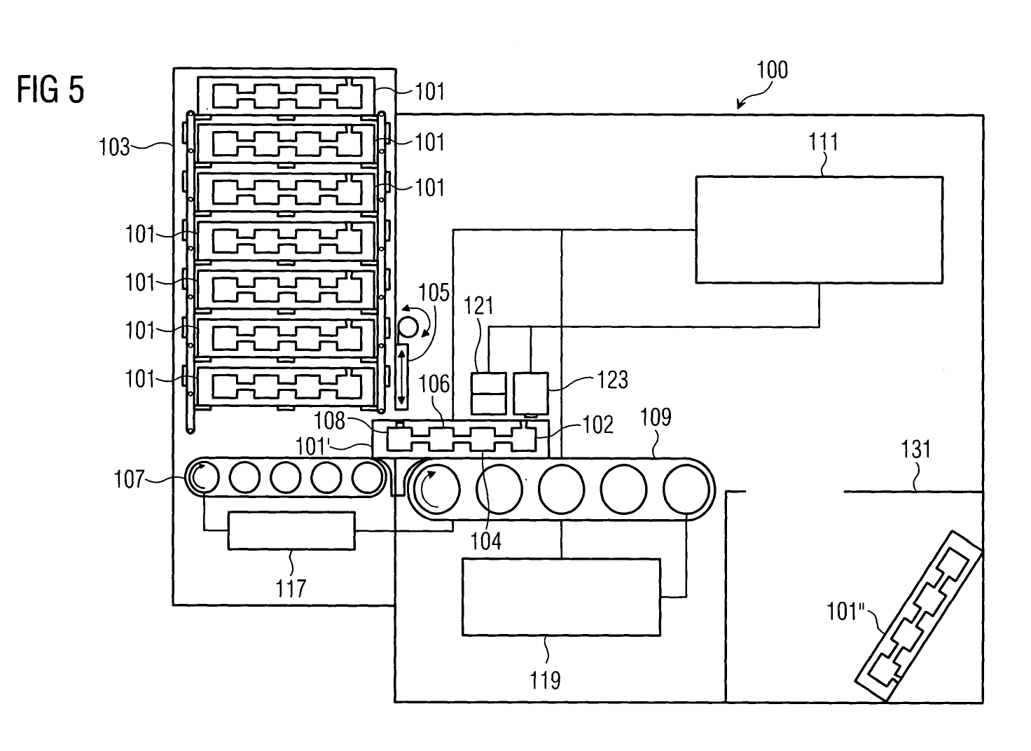

The DNA molecules bound to the magnetic beads 21 are usually present in a very low initial concentration in the sample, such that amplification of the nucleic acids has to take place for detection. For this purpose, the magnetic beads are moved into an amplification chamber 9, which is connected to the washing chamber 7 via the microchannel 27. An amplification, for example by way of polymerase chain reaction (PCR) or some other suitable amplification method, can take place in the amplification chamber 9. The reagents 37 required for the amplification reaction can be stored beforehand, e.g. in dry form, in the chamber 9. The arrangement contains a peltier element, by way of which thermal cycles can be carried out for the PCR reaction in the amplification chamber 9. As an alternative, other heating and/or cooling elements known to the person skilled in the art can also be present, e.g. a resistance heating element or a water cooling system. The construction of the arrangement is shown schematically in FIGS. 4 to 7, which will be discussed in detail below.

When the temperature is increased, the DNA molecules are generally detached from the magnetic beads 21. Consequently, the nucleic acids are then released for an amplification reaction and a later detection reaction. As an alternative it is also possible to amplify the nucleic acids using the oligonucleotides applied on the beads as a primer for the PCR reaction directly on the oligonucleotides. For this purpose, by way of example, a corresponding primer for the counter-strand can additionally also be provided in the amplification chamber, such that the amplified nucleic acids are then bound to the magnetic beads at one end via the probe oligonucleotides.

In order to detect the DNA, the nucleic acids bound to the magnetic beads 21 can be moved through a microchannel 29 into a detection chamber 11. Specific oligonucleotides in a detection unit are immobilized in the detection chamber 11. The amplified nucleic acids which are immobilized on the magnetic beads at one end hybridize with the probe oligonucleotides on the microarray and are thereby immobilized. The detection of the nucleic acid molecules sought takes place by detection of the immobilized magnetic beads at that location of the detection unit 39 at which the complementary oligonucleotides are arranged. For this purpose, the detection unit 39 comprises a sensor that can detect the presence of the magnetic beads 21 on the basis of the magnetic properties thereof, e.g. a magnetoresistive sensor. As an alternative, it is possible for the amplified nucleic acids hybridized to the probe oligonucleotides of the microarray to be detected optically, e.g. by way of fluorescent dyes, electrochemically, e.g. by redox cycling, or in some other way.

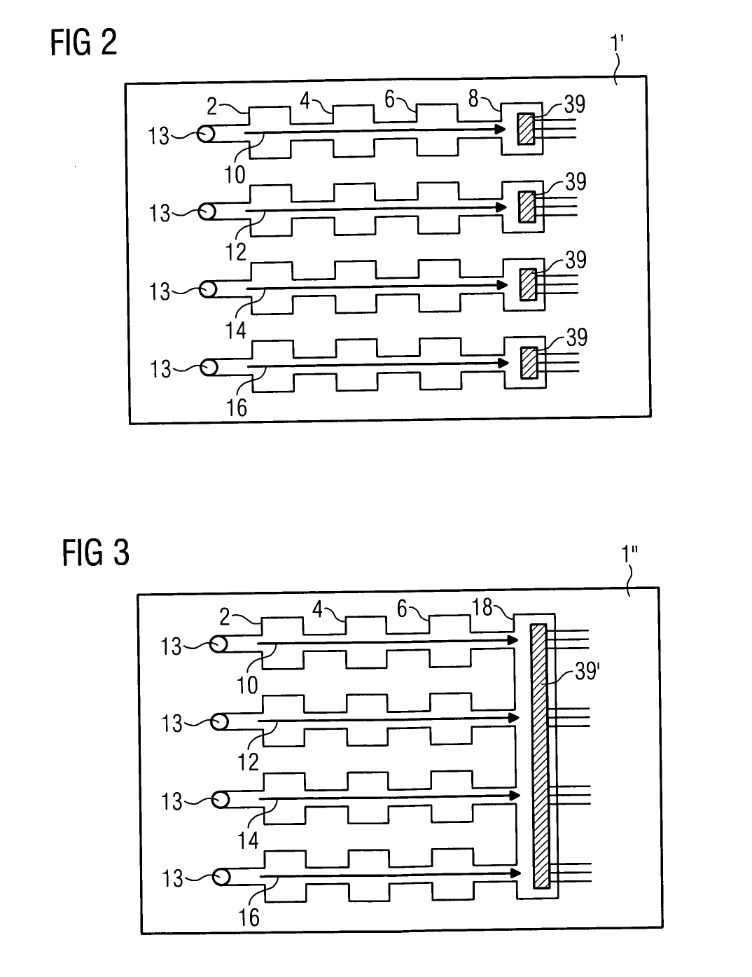

FIG. 2 illustrates a further embodiment of a microfluidic device of the arrangement according to an embodiment of the invention in the form of a cartridge 1′. The cartridge 1′ has four groups of process chambers 2, 4, 6, 8 respectively arranged along 4 reaction paths 10, 12, 14, 16. Via corresponding filling openings 13, samples are introduced into the cartridge and pass through the respective process chambers 2, 4, 6, 8 along the reaction paths 10, 12, 14, 16. It is noted at this point that only the process chambers along the reaction path 10 are designated by the reference symbols 2, 4, 6 and 8 in FIGS. 2 and 3, for reasons of clarity; the corresponding process chambers along the reaction paths 12, 14, 16 should likewise be designated by these reference symbols. A detection unit 39 of the type described above is provided in the detection chamber 8. In this way, four samples can be processed an analyzed in parallel in the cartridge 1′. It is also conceivable for two, three, or 5 or more, e.g. 10 or 20 sample sections or reaction paths to be arranged on a cartridge.

The expression “reaction path” denotes the path taken by the sample or the biological molecules to be examined in the method sequence through the device.

FIG. 3 shows a further alternative embodiment of a microfluidic device in the form of a cartridge 1″. In this embodiment, four groups of reaction chambers 2, 4, 6 are likewise arranged along four reaction paths 10, 12, 14, 16, such that four samples can be processed in parallel. The samples are conducted along the reaction paths 10, 12, 14, 16 through the respective process chambers 2, 4, 6 and are then conducted into a common detection chamber 18, in which a common detection unit 39′ is provided.

FIGS. 4 to 6 illustrate an arrangement 100 according to an embodiment of the invention in different operating states, which arrangement contains microfluidic devices 101, 101′, 101″, 101a, 101b, 101c, 101d. A plurality of microfluidic devices 101 are stacked in a magazine 103 embodied in stack-like fashion. The devices can already be filled with samples before being introduced into the magazine 103. As a result of an opening element 105 being opened and the transport units 107, 109 being advanced, the microfluidic device 101′ is conveyed out of the magazine 103. In the present example, in the arrangement 100 the transport unit embodied as conveyor belts 107, 109 defines a central transport section for the microfluidic devices 101, 101′, which forms a receptacle of the arrangement 100 for the microfluidic devices 101, 101′. At least one device/element for fixing the magnetic beads 121 (e.g. in the form of an electromagnet) and detection device 123 are provided along this transport section. This operation is coordinated by the controller 111, 117, 119. A microfluidic device 101″ that had already been processed previously has been transported into the collecting container 131.

FIG. 5 shows the arrangement according to an embodiment of the invention in a further operating state, which temporarily succeeds the operating state in accordance with FIG. 4. The microfluidic device 101′ is moved under a magnetic field generator 121 by the transport devices 107, 109. The magnetic field generator 121 can be embodied as a permanent magnet or as an electromagnet. The process chambers 102, 104, 106, 108 provided in the device 101′ embodied as a cartridge can be moved through under the magnetic field generator 121 by the transport device 107, 109. Through selective application of the magnetic field, the substrate-molecule complex is fixed under the magnetic field generator, while the microfluidic device 101′ continues to move. As a result, the molecules bound by the substrate are moved successively through the process chambers 102, 104, 106, 108. As an alternative, however, it is also possible to provide a moveable magnetic field generator which, with an immobile cartridge, moves the sample bound to magnetic beads relative to the cartridge. If an electromagnet is used, the magnetic field can be controlled (e.g. on/off) by the controller 111. The microfluidic device 101′ is moved further toward the right by the transport device 109. The opening element 105 is then closed again.

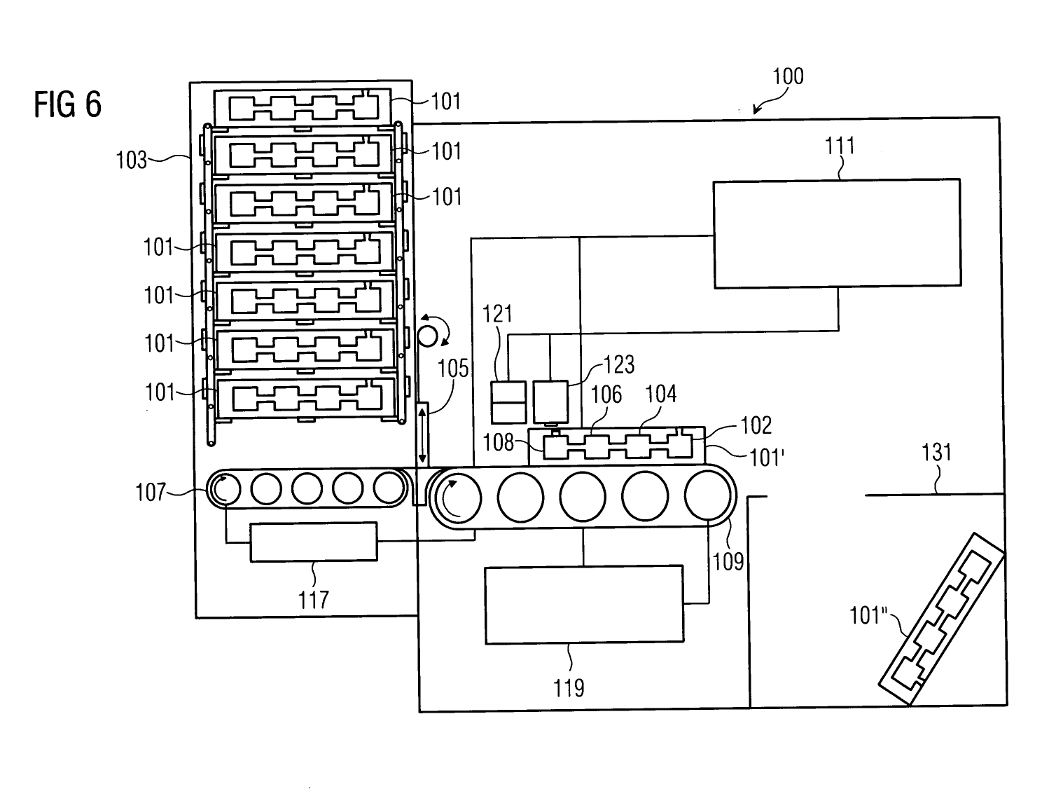

After the microfluidic device 101′ has been moved through under the magnet 121, the detection chamber 108 is then situated under a sensor 123 (FIG. 6), which can read out the signals from the detection unit in the detection chamber 108 in order to detect the presence or the concentration of biological molecules to be examined, e.g. nucleic acids. The detected signals can be conducted to the controller 111 and be supplied there for data processing. After the signals have been detected, the microfluidic device 101′ can be transported into the collecting container 131. The entire method sequence can then be repeated with the next microfluidic device 101 situated in the magazine, until all the samples have been processed. In this way, after the microfluidic devices 101 have been charged with the samples and the microfluidic devices 101 have been introduced into the magazine 103, it is possible for the entire number of samples to be processed without necessitating further intervention on the part of the operating personnel. Consequently, the entire analysis of the samples can proceed in automated fashion.

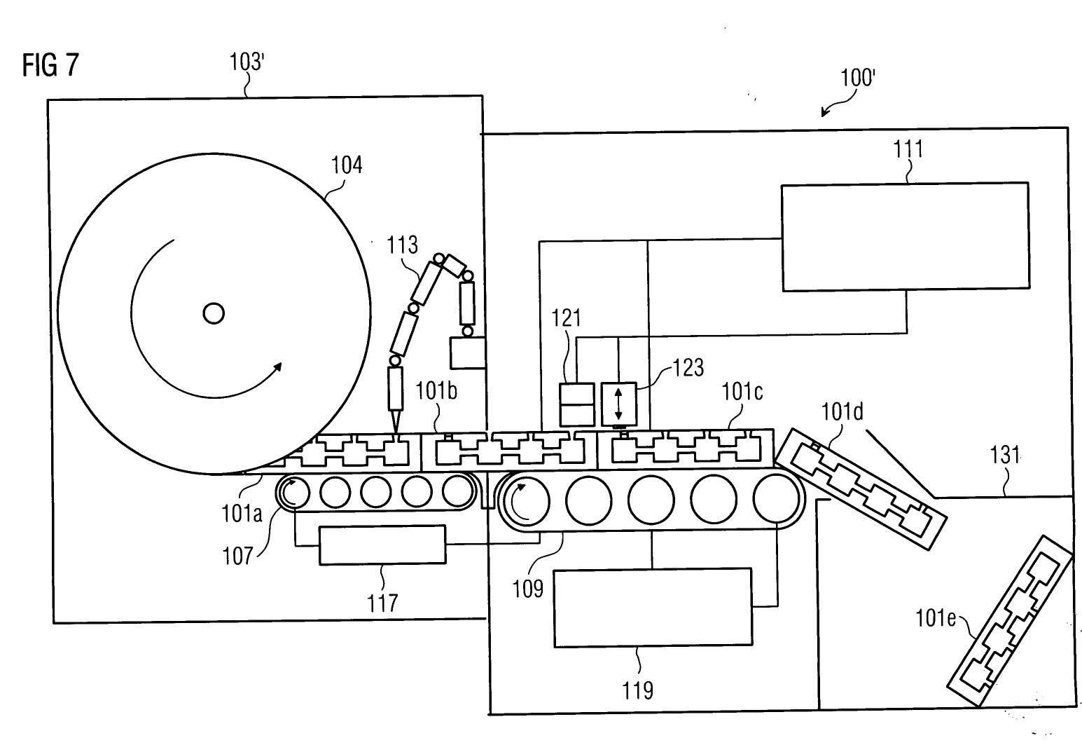

FIG. 7 shows an alternative embodiment of the arrangement according to the invention. Unfilled single-use microfluidic devices 101 configured as a cartridge are supplied in rolled-up form in the magazine 103′. The microfluidic devices can be rolled up e.g. on a flexible carrier strip. In order to analyze the samples, firstly a microfluidic device 101a is unrolled from the drum 104 and transported by the transport unit 107 to a unit for introducing the samples 113.

The unit can be configured e.g. in the form of a moveable pipetting arm. The samples are introduced into the microfluidic device 101a. The entire method proceeds like an assembly line; while the samples are introduced into the microfluidic device 101a, the microfluidic device 101b is moved under the magnet 121, with the result that the lysis and washing steps are carried out in the corresponding process chambers. The microfluidic device 101c is already situated under the sensor 123, where the signals are read out from the detection unit in the microfluidic device 101c. The microfluidic device 101d is transported into the collecting container 131, which already contains a used microfluidic device 101e.

In the manner illustrated a high number of samples can be processed in automated fashion, the risk of contaminations or operating errors being minimized. In particular by using cartridges on which a plurality of samples can be processed in parallel, a high sample throughput can be achieved in this way.

It is emphasized that the examples used are merely by way of example and illustrative. Many different variations are conceivable in particular with regard to the arrangement of components, the direction of the movement of the cartridge through the arrangement, which could also be circular, for example, and the sequence of lines and process chambers in the cartridge.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An arrangement for processing a plurality of samples for analysis, the arrangement comprising:
a receptacle for a microfluidic device, including means for binding at least one biological molecule provided in the microfluidic device;
means for moving the microfluidic device in the arrangement along at least one direction of movement; and
at least one magazine for supplying a plurality of microfluidic devices.

2. The arrangement as claimed in claim 1, further comprising:
a unit for moving means, provided in the microfluidic device, for binding at least one biological molecule relative to the microfluidic device.

3. The arrangement as claimed in claim 2, wherein the unit for moving means provided in the microfluidic device for binding at least one biological molecule relative to the microfluidic device comprises a magnetic field generator.

4. The arrangement as claimed in claim 1, further comprising:
means for amplifying the biological molecule in the microfluidic device.

5. The arrangement as claimed in claim 1, further comprising:
means for detecting the biological molecule.

6. The arrangement as claimed in claim 1, further comprising:
a unit for introducing a sample into a microfluidic device.

7. The arrangement as claimed in claim 1, further comprising:
a container for collecting used microfluidic devices.

8. The arrangement as claimed in claim 1, wherein the at least one magazine is a stack magazine, in which the microfluidic devices are stackable.

9. The arrangement as claimed in claim 1, wherein the at least one magazine is a drum magazine, in which the microfluidic devices are rollable on a roll.

10. The arrangement as claimed in claim 1, further comprising:
means for detecting a coding of a microfluidic device.

11. A method for processing a plurality of samples for analysis, the method comprising:
a) supplying an arrangement with a plurality of microfluidic devices, wherein the arrangement has at least one magazine for supply with microfluidic devices and wherein the microfluidic devices each contain at least one element for binding at least one biological molecule;
b) introducing a first sample, containing at least one biological molecule to be examined, into one of the microfluidic devices;
c) binding the biological molecule to be examined by the at least one element for binding at least one biological molecule; and
d) repeating steps b)-c) with the further samples until all the samples to be processed have been processed,
wherein the microfluidic device with the introduced sample is moved in the arrangement along at least one direction of movement.

12. The method as claimed in claim 11, wherein the at least one element means for binding the at least one biological molecule is movable relative to the microfluidic device.

13. The method as claimed in claim 11, wherein the introduction of the samples, containing biological molecules to be examined, into the respective microfluidic devices is effected before the supply of the arrangement with microfluidic devices.

14. The method as claimed in claim 11, wherein the at least one element for binding the at least one biological molecule have a substrate that can be linked to the molecule to form a substrate-molecule complex.

15. The method as claimed in claim 14, wherein, after the binding of the molecule to the substrate, the substrate-molecule complex is separated from the rest of the sample.

16. The method as claimed in claim 15, wherein the separation of the substrate-molecule complex from the rest of the sample is effected by moving the substrate-molecule complex relative to the rest of the sample.

17. The method as claimed in claim 11, wherein the at least one element for binding the at least one biological molecule comprise at least one magnetic element.

18. The method as claimed in claim 17, wherein a magnetic field is used for moving the at least one element for binding the at least one biological molecule relative to the microfluidic device.

19. The method as claimed in claim 11, further comprising:
amplifying the biological molecule by way of an amplification reaction.

20. The method as claimed in claim 11, further comprising:
detecting the biological molecule.

21. The method as claimed in claim 11, wherein the at least one element for binding the at least one molecule is moved along a reaction section in the microfluidic device, which leads into at least one process chamber.

22. The method as claimed in claim 21, wherein the at least one element for binding the at least one molecule is moved along a reaction section in the microfluidic device through a plurality of process chambers.

23. The method as claimed in claim 21, wherein the reaction section is oriented essentially along the at least one direction of movement in the arrangement.

24. The method as claimed in claim 21, wherein, in the microfluidic device, a plurality of samples are processed simultaneously in a corresponding number of reaction sections which are arranged essentially parallel in the microfluidic device.

25.-28. (canceled)

29. The method as claimed in claim 12, wherein the introduction of the samples, containing biological molecules to be examined, into the respective microfluidic devices is effected before the supply of the arrangement with microfluidic devices.

30. The method as claimed in claim 12, wherein the at least one element for binding the at least one biological molecule have a substrate that can be linked to the molecule to form a substrate-molecule complex.

31. The method as claimed in claim 22, wherein the reaction section is oriented essentially along the at least one direction of movement in the arrangement.

32. An arrangement for processing a plurality of samples for analysis, the arrangement comprising:
a receptacle for a microfluidic device, including at least one element to bind at least one biological molecule provided in the microfluidic device;
at least one device to move the microfluidic device in the arrangement along at least one direction of movement; and
at least one magazine to supply a plurality of microfluidic devices.

33. The arrangement as claimed in claim 32, further comprising:
a unit for moving device, provided in the microfluidic device, to bind at least one biological molecule relative to the microfluidic device.

34. The arrangement as claimed in claim 32, further comprising:
at least one device to amplify the biological molecule in the microfluidic device.

35. The arrangement as claimed in claim 32, further comprising:
at least one device to detect the biological molecule.

36. The arrangement as claimed in claim 32, wherein the at least one magazine is a stack magazine, in which the microfluidic devices are stackable.

37. The arrangement as claimed in claim 32, wherein the at least one magazine is a drum magazine, in which the microfluidic devices are rollable on a roll.
